(19) United States
(12) Patent Application Publication
(10) Pub. No.: US 2004/0140194 A1
(43) Pub. Date: Jul. 22, 2004

(54) Nonthermal plasma air treatment system

(76) Inventors: Roy M. Taylor JR., Rockford, MI (US); Roy W. Kuennen, Caledonia, MI (US)

Correspondence Address: ROY M. TAYLOR, JR., 900 Fifth Third Center, 111 Lyon Street, N.W., Grand Rapids, MI, 49503-2487, US

(21) Appl. No.: 10/636,471

(22) Filed: Aug. 7, 2003

Related U.S. Application Data
(60) Provisional application No. 60/401,665, filed on Aug. 7, 2002.

(51) Int. Cl. B01J 19/08; B01J 19/12

(52) U.S. Cl. 204/164; 422/186.04

(57) ABSTRACT

A method and apparatus for reducing air contamination using a contaminant adsorbent to remove contaminants from air, and a nonthermal plasma to desorb and oxidize or detoxify the contaminants. The adsorbent may be comprised of a unique combination of a zeolite with a material having a high dielectric value. The power supply for the nonthermal plasma reactor is designed to seek and operate at the system resonant frequency. In one embodiment, the adsorbent material is separated from the nonthermal plasma reactor. In this embodiment, heat is applied to the adsorbent material to thermally desorb contaminants during a desorption/regeneration phase. Air is recirculated within the system to move desorbed contaminants from the adsorbent material to the nonthermal plasma reactor for decomposition. The recirculating air repeatedly moves contaminants through the reactor until they are destroyed or the desorption/regeneration phase is complete.

This application claims the benefit of U.S. Provisional Application No. 60/401,665, filed Aug. 7, 2002.

### FIELD OF THE INVENTION

The present invention relates to the use of nonthermal plasma in conjunction with an air filtration system to treat indoor air for the reduction of contaminants.

### BACKGROUND OF THE INVENTION

Numerous air purification systems are described in the literature and available in the marketplace. These systems rely on various techniques to remove and detoxify waste gases, volatile organic compounds, odors, nitrogen oxides, sulfur oxides, toxic gases, etc., hereinafter referred to as contaminants. These systems rely on a variety of methods, such as combustion, adsorption, catalytic or nonthermal plasma processes to remove airborne contaminants.

The combustion systems are the simplest in principle, and comprise primarily of heating the air, causing thermal decomposition or combustion of the airborne contaminants. However, this method is uneconomical because it requires large amounts of energy to effectively remove the contaminants from the air. This method also can create large amounts of thermal pollution.

The adsorption method relies on the use of an adsorbent material to capture airborne contaminants. However, this method requires the frequent replacement or regeneration of the adsorbent material, resulting in higher operating costs for these systems.

The catalytic method relies on the use of catalysts to accelerate the chemical reactions that convert airborne contaminants into relatively harmless chemical components. However, the catalytic method generally requires impracticably high energy requirements when the concentration of the contaminants are low. Furthermore, the catalysts used by these systems may be subject to poisoning by the contaminants, resulting in a substantial decline or complete loss of catalytic function.

Typical nonthermal plasma systems rely on the use of a nonthermal plasma to treat air streams that contain contaminants. A nonthermal plasma is a high voltage electrical discharge between the two electrodes. This discharge creates high energy electrons in the air, which collide with gas molecules and create free radicals. These free radicals oxidize the contaminants in the airstream. Most of the reactants are produced from oxygen, producing a number of different oxygen species. However, free radicals are also formed from nitrogen and water vapor that may be in the airstream. Because most of the energy consumed by the nonthermal plasma systems is used to create high energy electrons, the temperature of the airstream being treated by these systems remains essentially unchanged. The high voltage that powers the plasma can be in the form of an alternating current, direct current or pulsed current, with a rapid rise time pulse in a pulsed current having the highest performance.

Generally, a nonthermal plasma air treatment system is comprised of a nonthermal plasma reactor and a means for moving air through the reactor. The nonthermal plasma reactor is comprised of a plurality of opposing electrodes, and is generally manufactured according to one of two configurations: corona discharge or dielectric barrier discharge. Corona discharge reactors use bare electrodes and the nonthermal plasma is created between them. The dielectric barrier reactor has a dielectric coating on the one or both electrodes, or has a packed bed containing a dielectric material between the electrodes.

Nonthermal plasma systems can suffer from several deficiencies, such as oxidation by products, ozone production, and high electrical energy requirements. Oxidation by-products are the result of incomplete oxidation, and new contaminants can be formed in the airstream, defeating the purpose of the system. Ozone is thought to be harmful, so the creation of ozone also may defeat the purpose of these systems. Finally, the high energy requirements for many nonthermal plasma systems render these systems impracticable.

As noted above, nonthermal plasma is typically created by applying high electrical power to a plasma reactor. Some conventional nonthermal reactors require hundreds of joules of electric energy to treat a liter of air. This need for large amounts of electrical energy presents a significant challenge to conventional nonthermal plasma systems. The power supply issues are further complicated by the fact that the parameters necessary to enable and control nonthermal plasma can vary dramatically not only from reactor to reactor, but also from time to time within the same reactor. For example, for a nonthermal plasma system that includes a packed bed of dielectric material between the electrodes, the conductivity of the bed of dielectric material can vary as a result of changes in humidity in the air being treated and changes in the quantity and type of contaminants in the bed. These variations can also result in significant changes in the impedance of the bed. As the conductivity and impedance of the bed changes, the amount of power required to generate and maintain nonthermal plasma also changes.

Another known problem associated with nonthermal plasma reactors is caused by “streamers” that can form in the reactor. Streamers are essentially self-propagating electron streams that, if left unchecked, may transition into an arc and/or cause the nonthermal plasma to transition into a thermal plasma condition. This can have significant adverse effects on the bed and on the performance of the system. To avoid arcing or a transition to a thermal plasma condition, the streamers must be terminated or quenched quickly after being formed. To achieve this function, conventional nonthermal plasma reactors are required to include relatively complex external or self-quenching mechanisms.

It is therefore an object of the present invention to provide an air treatment system that remedies some or all of the deficiencies found in the systems described above.

### SUMMARY OF THE INVENTION

The present invention provides a method and apparatus for the effective and efficient removal and destruction of airborne contaminants, while minimizing the release of oxidation byproducts. The present invention also provides a nonthermal plasma reactor design for use in conjunction with a nonthermal plasma air treatment system. In a further aspect, the present invention provides a power supply for a nonthermal plasma reactor that includes an inductive coupling for transferring power from a ballast circuit to a secondary circuit containing the nonthermal plasma reactor.

In one embodiment of the present invention, a nonthermal plasma reactor is provided that is comprised of a plurality of opposing electrodes, with one or more packed beds of material with a relatively high dielectric constants between the electrodes. In another embodiment of the present invention, a nonthermal reactor is provided that is comprised of a plurality of opposing electrodes, with one or more packed beds of material between the electrodes, wherein the packed bed is further comprised of an absorbent material and a material with a relatively high dielectric constant. In another embodiment of the present invention, a nonthermal reactor is provided that is comprised of a plurality of opposing electrodes, with one or more packed beds of material between the electrodes, wherein the packed bed is further comprised of an absorbent material, a material with a relatively high dielectric constant, and a catalyst used to aid in the destruction or detoxification of ozone, or accelerate the oxidation reactions.

In an alternative embodiment, the adsorbent material is separated from the nonthermal plasma reactor. In this embodiment, a heating device is provided to provide thermal desorption of the adsorbent and a fan is provided to circulate the air repeatedly through the reactor. The separate heating device can provide quicker heat-up time and a higher operating temperature than the nonthermal plasma reactor. Accordingly, the separate heater can shorten the time required for the desorption/regeneration phase. Further, by separating the nonthermal plasma reactor from the adsorbent material, the size of the plasma reactor can be reduced. Instead of including a nonthermal plasma reactor that is of essentially the same size as the adsorbent material, a significantly smaller reactor can be provided. A smaller reactor requires a smaller power supply and has reduced power consumption during operation. The cost of the reactor can also be reduced.

In another embodiment, the inductive coupling between the power supply and the nonthermal plasma reactor includes a primary and a secondary that are separated by an air gap, which provides a degree of isolation between the ballast and the secondary circuit. This air gap can be selected to provide a current limiting function that limits the formation of streamers in the bed.

In another embodiment of the present invention, the primary of the ballast circuit is electrically connected within a resonant tank circuit and the ballast circuit includes a current sensing circuit that monitors the current applied to the primary. The ballast circuit varies the frequency of the signal applied to the resonant tank circuit as a function of the measured current. In an embodiment, the current sensing circuit includes a transformer with at least one primary electrically connected to the resonant tank circuit and a secondary located in the ballast circuit. The current sensing circuit provides a dynamic power supply that can vary its frequency to seek resonance over a range of reactor characteristics. Because the ballast circuit can self-adjust to provide resonance despite changes in the characteristics of the reactor, it permits the use of a smaller and more efficient power supply.

In another embodiment, the power supply also includes a load sensing circuit that monitors the characteristics of the bed and adjusts the power supplied to the nonthermal plasma reactor based on the monitored characteristic. In one embodiment, the load sensing circuit measures the impedance of the bed and adjusts the power supplied to the nonthermal plasma reactor based on the measured impedance. This permits the ballast circuit to adjust to changes in the characteristics of the bed, perhaps most notably humidity which can have a material affect on the generation and maintenance of plasma within the bed.

These and other objects, advantages, and features of the invention will be readily understood and appreciated by reference to the detailed description of the preferred embodiment and the drawings.

### BRIEF DESCRIPTION OF THE DRAWINGS

FIG. 1 depicts one embodiment of a nonthermal plasma air treatment system of the present invention;

FIG. 2 depicts one embodiment of the nonthermal plasma reactor used in the air treatment system;

FIG. 3 depicts one embodiment of the nonthermal plasma reactor used in the air treatment system;

FIG. 4 depicts one embodiment of the nonthermal plasma reactor used in the air treatment system;

FIG. 5 depicts one embodiment of the nonthermal plasma reactor used in the air treatment system;

FIG. 6 depicts one embodiment of the nonthermal plasma reactor used in the air treatment system;

FIG. 7 depicts one embodiment of the nonthermal plasma reactor used in the air treatment system;

FIG. 8 depicts one embodiment of the nonthermal plasma reactor used in the air treatment system;

FIG. 9 depicts one embodiment of the nonthermal plasma reactor used in the air treatment system;

FIG. 10 depicts one embodiment of the nonthermal plasma reactor used in the air treatment system;

FIG. 11 depicts several embodiments of the electrodes used in the nonthermal plasma reactor.

FIG. 12 is a block diagram of the major circuits and assemblies of the air treatment system;

FIG. 13 is a block diagram of the inductively coupled ballast circuit;

FIG. 14 is an electrical circuit schematic of a portion of the inductively coupled ballast circuit, the current sensing circuit and the interlock circuit;

FIG. 15 depicts a plurality of waveforms representing operation of the current sensing circuit;

FIG. 16 is an electrical circuit schematic of the current limit circuit;

FIG. 17 is an electrical circuit schematic of a portion of an alternative current sensing circuit;

FIG. 18 is a schematic diagram of an air treatment system in accordance with an alternative embodiment of the present invention; and

FIG. 19 is a an exploded perspective view of the nonthermal plasma reactor of the embodiment shown in FIG. 18.

### DETAILED DESCRIPTION OF THE ILLUSTRATED EMBODIMENT

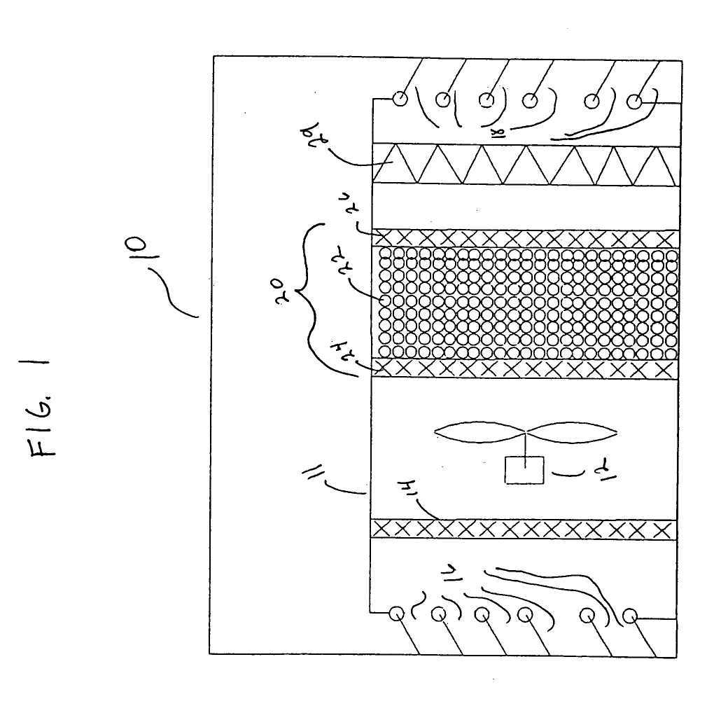

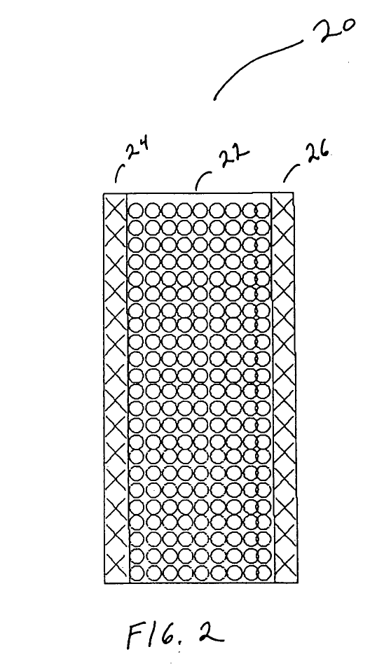

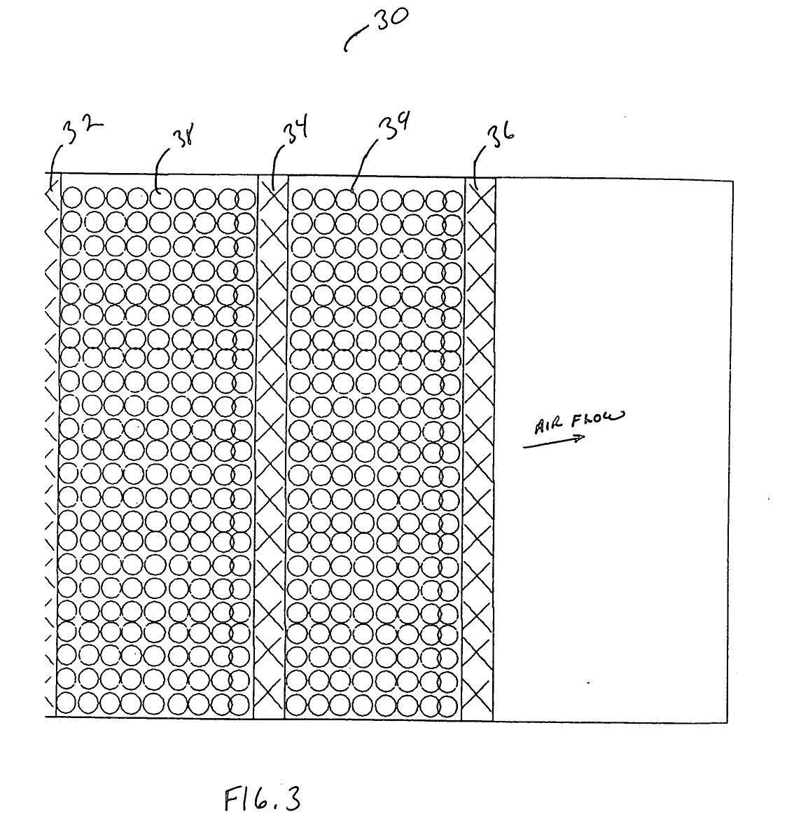

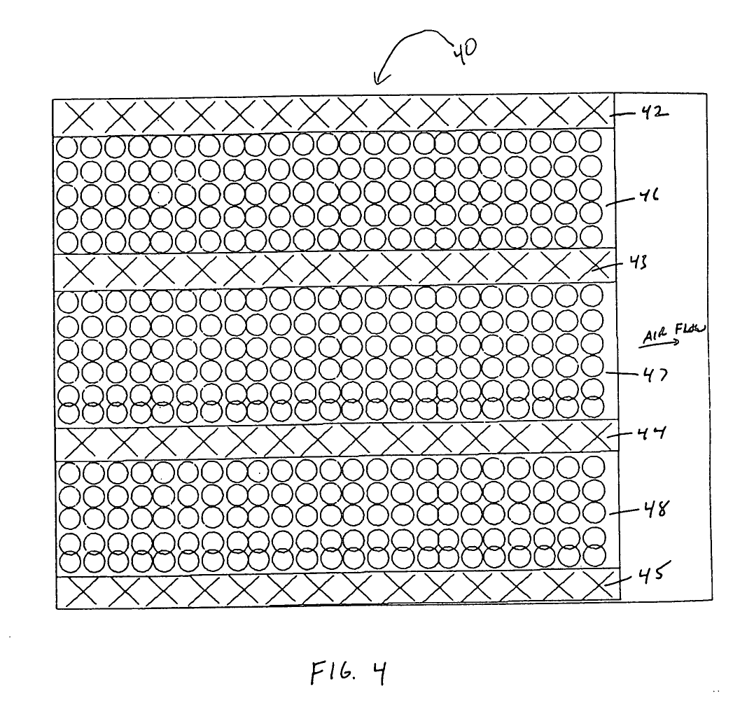

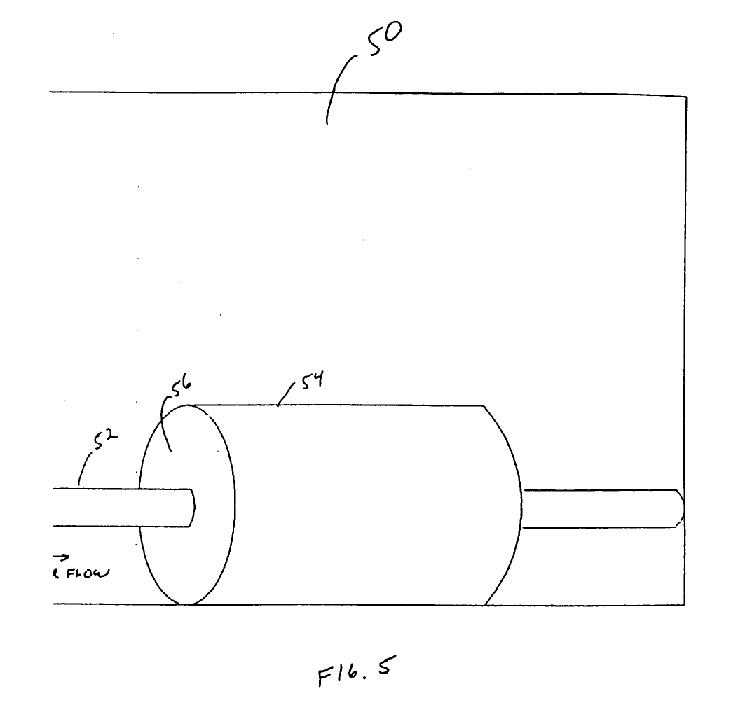

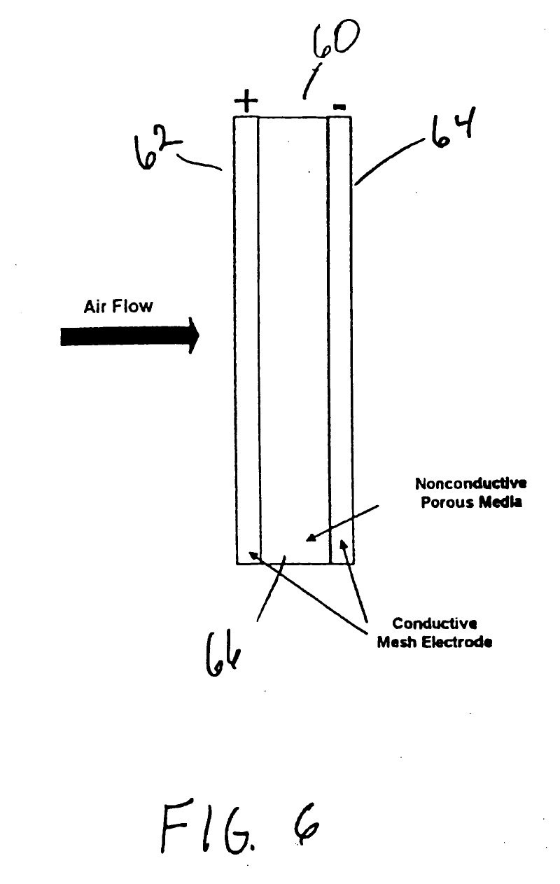

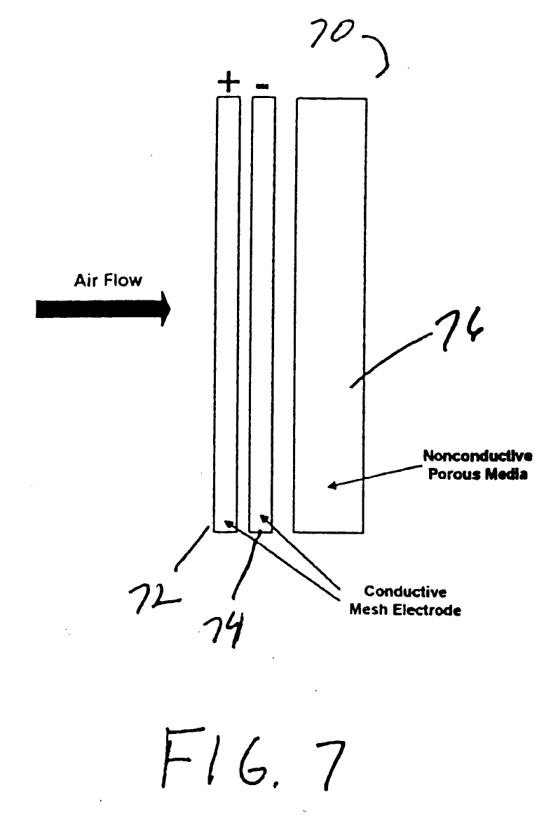

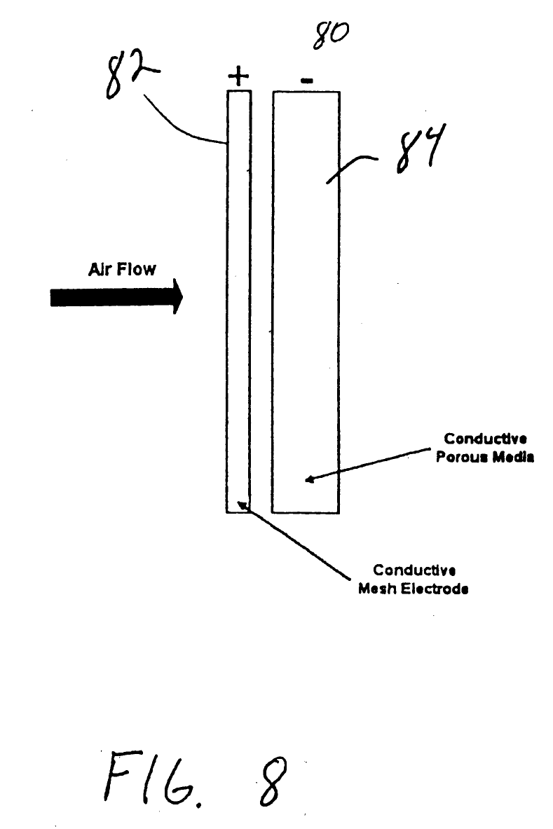

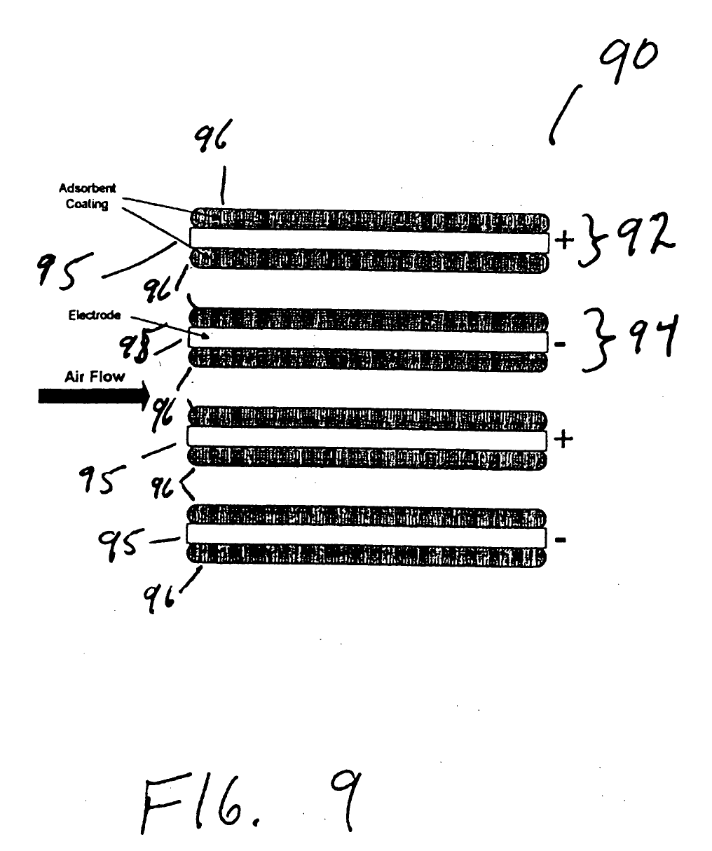

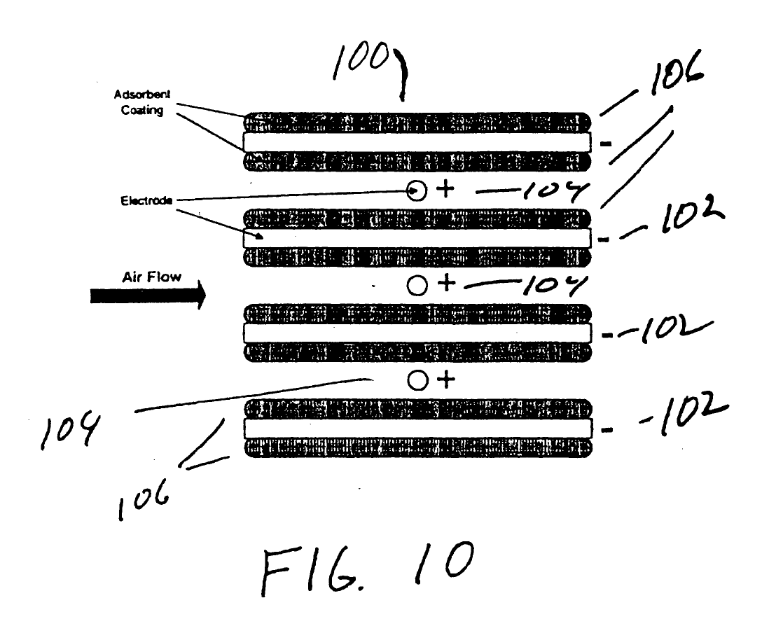

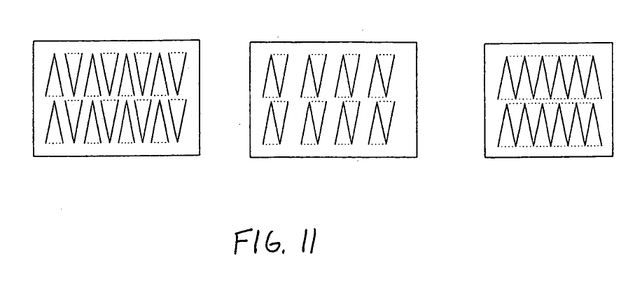

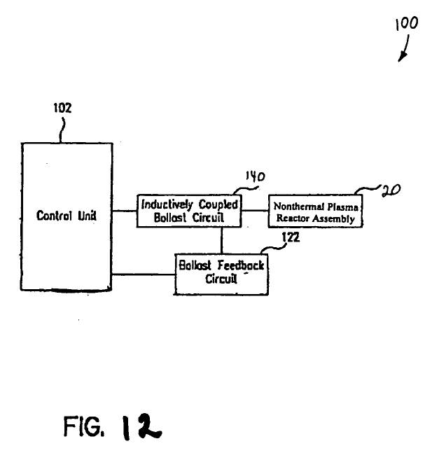

FIG. 1 illustrates one embodiment of the present invention. The air treatment system 10 is comprised of a housing 11, and a nonthermal plasma reactor 20 comprising a bed of an adsorbent material 22 located between two opposing electrodes 24 and 26. Optionally, air treatment system 10 is further comprised of a fan 12, a set of inlet vanes 16, a set of outlet vanes 18, a prefilter 14, and a HEPA filter 29.

A typical operation cycle of air treatment system 10 is comprised of two phases of operation; an adsorption phase and a desorption/regeneration phase. During the adsorption phase, vane sets 16 and 18 are open and fan 12 is turned on, causing air to move first through open vane set 16 and then through the prefilter 14 and into the nonthermal plasma reactor 20. Those skilled in the art would recognize that fan 12 could easily be replaced by a blower or other air-movement mechanism known in the art. Power is supplied to the fan 12 and vane sets 16 and 18 using power and power switching systems well known in the art. Airborne contaminants are captured by the adsorbent material in the packed bed 22. Finally, air moves through HEPA filter 29, then through vane set 18 and out of system 10. A person skilled in the art would recognize that the above identified components could be rearranged within the air treatment system 10. For example, HEPA filter 29 could be placed between fan 12 and reactor 20.

At completion of the adsorption phase, air treatment system 10 enters the desorption/regeneration phase. During this phase of operation, vane sets 16 and 18 are closed, and fan 12 may be turned off, effectively isolating the interior of air treatment system 10 from the surrounding environment. Electrodes 24 and 26 are then energized, creating a nonthermal plasma. This nonthermal plasma oxidizes or detoxifies the contaminants entrained in the air gaps within the packed bed of adsorbent material 22. As these contaminants are oxidized or detoxified, contaminants are desorbed by the adsorbent bed. These contaminants are also oxidized or detoxified by the nonthermal plasma. The nonthermal plasma elevates the temperature of the adsorbent bed, which serves to further assist in the desorption of contaminants. Because air treatment system 10 is isolated from the surrounding environment during the desorption/regeneration phase, most oxidation by-products created during this phase are trapped within the air treatment system 10 and detoxified by the nonthermal plasma. Adsorbent bed may further include a catalyst to aid in the destruction or detoxification of ozone. Fan 12 may be operated during the desorption/regeneration phase to circulate air within air treatment system 10 and reactor 20.

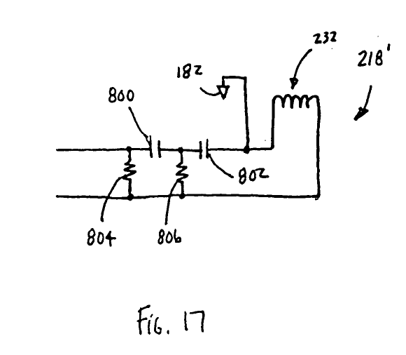

A schematic illustration of an alternative air treatment system 10′ is shown in FIG. 18. The system 10′ generally includes a housing 11′, a nonthermal plasma reactor 20′, an adsorbent material 22′, a heat source 23′ and fan 12′. The system 10′ also includes structure for selectively closing the interior of the system 10′ off from the environment during the desorption/regeneration phase, and an air recirculating system 21′ for recirculating air through the system during the desorption/regeneration phase. In the illustrated embodiment, this structure includes vane sets 16′ and 18′, which can be pivoted to open and close the inlet and outlets of the system 10′. The vane sets 16′ and 18′ can be replaced by other similarly functioning structure, such as a sliding or pivoting door. A further alternative may include a pair of adjacent perforated plates in which at least one of the two plates is movable to selectively align or misalign the perforation of the two plates. This system 10′ may optionally include a pre-filter 14′, a HEPA filter 29′ and/or other conventional air treatment components.

In this system 10′, the adsorbent material 22′ is separated from the nonthermal plasma reactor 20′. The adsorbent material 22′ may be located upstream (See FIG. 18) or downstream (not shown) from the reactor 20′. In the illustrated embodiment, the adsorbent material 22′ is a generally conventional activated-carbon fabric that adsorbs contaminants in a generally conventional manner. The fabric may be pleated to provide increased surface area. The carbon fabric can be replaced by other adsorbent materials, such as a packed bed of activated carbon (not shown), or a pressed activated carbon filter (not shown). Because the nonthermal plasma reactor 20′ is separated from the adsorbent material, the system 10′ includes heat source 23′ for selectively generating heat to cause thermal desorption of the carbon fabric 22′ during the desorption/regeneration phase. The heat source 23′ may be an array of conventional heat lamps, such as the infrared heat lamps 23′ shown schematically in FIG. 18. Alternatively, the heat source may be heat generating wires (not shown) extending along or through the fabric 22′, steam generator (not shown), an electric or gas heater (not shown) or other conventional heat sources. As a further alternative, the heat source may simply include an electric circuit for applying a current to the fabric 22′.

The air recirculating system 21′ generally includes a recirculating fan 35′, an air return 31′ for causing air to circulate within the system 10′ during the desorption/regeneration phase and a vane set 19′ for closing off the air return 31′ during the adsorption phase. In the illustrated embodiment, fan 35′ is separate from fan 12′. Alternatively, a single fan may be provided to perform both functions, for example, to move air through the system 10′ during the adsorption phase and to circulate air through the system 10′ during the desorption/regeneration phase. The air return 31′ provides a flow path from a point downstream of the nonthermal plasma reactor 20′ to a point upstream of the adsorbent material 22′. In the illustrated embodiment, the air return 31′ provides a flow path from a location just upstream of vane set 18′ to a point just downstream of vane set 16′. The configuration of air return 31′ causes recirculating air to pass through all of the internal air treatment components. This is not necessary, however, and the configuration of the air return 31′ may be varied to exclude certain components, such as the pre-filter 14′ and HEPA filter 29′, from the recirculation flow path. Vane set 19′ operates in a conventional manner as described above in connection with vane sets 16′ and 18′. Vane set 19′ can be replaced by other structure for opening and closing the air return 31′.

Like air treatment system 10, air treatment system 10′ operates in a two phase cycle. During the adsorption phase, vane sets 16′ and 18′ are opened and fan 12′ is energized to move air from the environment through the system 10′. During this phase, vane set 19′ is closed to seal off the air return 31′ and fan 35′ is powered off. This prevents air from recirculating through the system 10. The air passes through various levels of treatment at the pre-filter 14′, HEPA filter 29′ and carbon fabric adsorbent 22′. At the appropriate time, the system 10′ switches from the adsorption phase to the desorption/regeneration phase.

During the desorption/regeneration phase, the vane sets 16′ and 18′ are closed to seal the interior of the system 10′ off from the environment. Also, vane set 19′ is opened and fan 35′ is energized to move air through the air return 31′, thereby establishing a recirculating air flow within the system 10′. Additionally, the heat source 23′ and nonthermal plasma reactor 20′ are activated. The heat source 23′ generates heat that causes thermal desorption of contaminants from the carbon fabric 22′. The fan 35′ moves air through pre-filter 14′, HEPA filter 29′ and then the carbon fabric 22′. As the air passes through the carbon fabric 22′, it draws away the desorbed contaminants. The moving air then passes through the plasma generated by the reactor 20′ to break down the contaminants. Finally, the fan 35′ moves the air back to the beginning of the air treatment system via air return 31′ to recirculate the air through the pre-filter 14′, HEPA filter 29′, carbon fabric 22′ and the nonthermal plasma reactor 20′. In this way, air moves desorbed contaminants from the carbon fabric 22′ to the plasma reactor 20′ where they are destroyed. Because the air continually circulates through the system 10′, contaminants that are not destroyed in a single pass will recirculate through the system 10′, returning to the plasma reactor 20′. Depending on the timing of the desorption/regeneration phase, contaminants may pass through the reactor 20′ numerous times. The timing of the desorption/regeneration phase can be controlled by predetermining the amount of time necessary to provide the desired level of desorption/regeneration and then programming that timing into the controller. Alternatively, the system 10′ may include conventional sensors (not shown) that continually monitor the level of contaminants in the air moving through the systems 10′. The information provided by the sensors (not shown) can be used to trigger the desorption/regeneration phase, for example, when the contaminant level in the air output exceeds a predetermined threshold, and to determine when that phase is complete, for example, when the contaminant level in the circulating air falls below a predetermined threshold.

### Reactor

Adsorbents

As shown in FIG. 2 the reactor of the illustrated embodiment is comprised of opposing electrodes 24 and 26, with a bed of adsorbent material in between. The adsorbent of the illustrated embodiment is designed to provide a relatively large surface area to volume ratio, and is comprised of a hydrophobic zeolite and a material of a particular dielectric value. Zeolites are a class of natural occurring and synthetic compounds that are microporous crystalline solids with a defined pore structure. The most common zeolites are composed of silicon, aluminum and oxygen atoms, which form a three dimensional structure with voids, in which organic compounds can adsorb. However, a number of other elements may be incorporated within the structure. Different ratios of silicon to aluminum, and the inclusion of other elements change the bonding in the zeolite, which determines the shape and dimensions of the voids. As the amount of silicon increases in relationship to the amount of aluminum, zeolites tend to become more hydrophobic. These zeolites adsorb less water vapor as the humidity increases, and are better adsorbents for VOCs.

A dielectric material is a material that is a poor conductor of electric current, but an efficient supporter of electrostatic fields. Metal oxides, in general, have high dielectric value. An example of a material with a high dielectric value is barium titanate. The adsorbent bed of the present invention contains an adsorbent, such as a zeolite, and a material with a high dielectric value, such as barium titanate. In one embodiment of the present invention, barium titanate powder is mixed with a binder, such as boehmite alumina, dispersed in water and sprayed onto an extruded zeolite pellet. This would form, after drying, an adsorbent pellet coated with a high dielectric material. In another embodiment of the present invention, the adsorbent is comprised of a zeolite blended with a material of high dielectric value, and extruded into small beads, spheres, extruded pellets, powders, and ground or crushed to various particle sizes. Suitable binders to attach the high dielectric value material to the zeolite include sodium silicate, alumina, colloid alumina and colloidal silica.

In another embodiment of the present invention, an adsorbent such as activated carbon could be extruded into a suitable form, and then coated with a material with a high dielectric value, such as barium titanate. The coating should be sufficient to coat the carbon granules with an insulating material and prevent arcing through the bed. Activated carbon has the advantage of higher adsorption capacity than zeolites, but the performance can be quite dependent on humidity.

FIG. 3 illustrates a multi-bed reactor with 2 beds of adsorbent material 38 and 39 sandwiched between three electrodes 32, 34 and 36. The electrodes are configured such that the center electrode 34 opposes the two outside electrodes 32 and 36. In this configuration, the air flowing through the reactor flows in a direction perpendicular to the electrodes. One skilled in the art could readily recognize that the reactor could be constructed with multiple adsorbent beds located between opposing electrodes.

FIG. 4 illustrates a multi-bed reactor with three beds of adsorbent material 46, 47, and 48, sandwiched between opposing electrodes 42, 43, 44, and 45. In this configuration, the air flows through the reactor in a direction parallel to the electrodes 42, 43, 44, and 45. One skilled in the art could readily recognize that the reactor could be constructed with multiple adsorbent beds located between opposing electrodes.

FIG. 5 illustrates a cylindrical reactor, with a first electrode 52 placed at the core of the cylinder, a second electrode 54 defining the outer surface of the cylinder, and the volume between the core and the outer surface being at least partially filled with an adsorbent material 56 as described above.

An alternative reactor design is provided by coating an air permeable substrate with an adsorbent as described above. A suitable structure would allow air to pass through, yet the path of the air through the media make it likely that the air would contact the adsorbent. Possible configurations for the air permeable substrate include:

honeycomb monoliths, made of ceramics, inorganic fibers, metals or plastics;

fibrous substrates;

reticulated foams;

metal mesh or expanded metal;

a monolith made from corrugated materials.

It would be obvious to one skilled in the art that other structures could be used.

In alternative air treatment system 10′, the adsorbent material 22′ is separated from the reactor 20′. Accordingly, the reactor 20′ need not include an adsorbent material. In the illustrated embodiment, the reactor 20′ is disposed downstream from the adsorbent material 22′ along the flow path followed by air during the adsorption phase. The reactor 20′ may alternatively be disposed in essentially any location along the flow path followed by air during the desorption/regeneration phase. Referring now to FIG. 19, the reactor 20′ of system 10′ generally includes a pair of opposing electrodes 24′ and 26′ disposed on opposite sides of spacer 25′. In the illustrated embodiment, the electrodes 24′ and 26′ are manufactured from conventional stainless steel mesh. The spacing of the mesh is selected primarily to prevent any dielectric materials or catalysts from spilling from the reactor 20′. The reactor 20′ may alternatively include electrodes of essentially any conventional constructions. The spacer 25′ of this embodiment is a ceramic peripheral frame, for example, a rectangular frame as shown in FIG. 19. The spacer 25′ may include a replaceable plug 27′ that permits access to the interior 37′ of the reactor 20′. In this embodiment, the plug 27′ is removable to permit a dielectric material 33′ and/or a catalyst to be disposed within the interior 37′ of the reactor 20′. The dielectric material improves the operation of the plasma and may include any of a wide variety of conventional dielectric materials. In this embodiment, the dielectric material 33′ includes a plurality of alumina beads, which provide a reasonable balance between cost and dielectric constant for many applications. The beads are typically of a larger diameter than the openings in the electrodes 24′ and 26′ to entrap the beads in the reactor 20′. The dielectric beads 33′ are poured into the reactor 20′ by removing plug 27′. After the dielectric beads 33′ are installed, the plug 27′ is returned to enclose the dielectric beads 33′. The plug 27′ may be secured to the spacer 25′ with adhesives or mechanical fastening structures. For example, the plug 27′ may be frictionally fitted within the spacer 25′, may include a snap (not shown) to permit the plug 27′ to be snap-fitted in place or may be secured by screws or other fasteners (not shown). Alternatively, the plug 27′ may be removed and the dielectric material can be added during assembly of the reactor 20′, for example, before attaching the final electrode 24′ or 26′ to the spacer 25′. As described in more detail below, the reactor 20′ may also include one or more catalysts that facilitate decomposition of contaminants. A separate catalyst may be added to the interior 37′ along with the dielectric material or a dielectric material may be selected that has the desired catalytic properties. Although the reactor 20′ is illustrated as a rectangular box, the size, shape and configuration of the reactor 20′, including the electrodes 24′, 26′ and the spacer 25′ may vary from application to application as desired. For example, the size and shape of the reactor 20′, including the electrodes 24′, 26′ and the spacer 25′, may be varied to accommodate the size constraints of the corresponding air treatment system housing.

Catalysts

Catalysts can increase rate of decomposition of organic contaminants in a nonthermal plasma. Since ozone is formed in the nonthermal plasma, catalysts that help decompose ozone have application in the reactor. Therefore, the adsorbents used in this type of product could include the addition of a catalyst. Potential catalysts are the noble metals such as platinum and palladium, tin oxide, tungsten oxide, manganese oxides, copper oxides, iron oxides, cerium oxides, vanadium oxides, or mixtures thereof. It would be obvious to one skilled in the art that other catalysts could be used.

An alternative to adding the catalyst to the adsorbent is to include the catalyst in the reactor on a separate media, such as a reticulated foam, or other substrate with a high surface area.

Activated carbon is also very effective for the decomposition of ozone, although the carbon is a reactant, rather than a catalyst. Activated carbon could be used in the form of activated carbon cloth, in the form of small particles supported on a media with a large surface area, or in the form of a packed bed of larger particles.

In air treatment system 10′, a catalyst can be added to provide improved decomposition of contaminants. The catalyst may be disposed on adsorbent material 22′, in the nonthermal plasma reactor 20′ or in other locations along the air recirculation flow path. In the embodiment illustrated in FIGS. 18 and 19, the catalyst (not shown) is added to the nonthermal plasma reactor 20′. More specifically, the catalyst is coated on the surface of the dielectric beads 33′. The catalyst-coated dielectric beads 33′ are disposed within the interior 37′ of the reactor 20′. The beads may be coated with barium titanate, titanium dioxide, manganese dioxide or other catalysts, such as other metal oxides, to provide improved decomposition rates for ozone and other contaminants.

Electrode Design

The electrodes of the present invention are designed to create a multitude of streamers, or groups of high energy electrons leaving the electrode surface. In one embodiment of the present invention, the reactor is designed as a dielectric barrier discharge reactor, in which at least one the electrodes is coated with a dielectric material, or there is a dielectric material between the electrodes. A high voltage AC or pulsed electrical power is applied to the electrodes. A charge builds up on the surface of the dielectric material and the charge is discharged into the air. The charge on the surface requires a time to recharge in the location of the discharge. This type of dielectric barrier system has the advantage in that it is not likely to have an arc strike between the two electrodes. The disadvantage of a dielectric barrier discharge is that it requires more power to treat a given amount of air.

In another embodiment of the present invention, the reactor uses bare electrodes and does not contain a dielectric barrier. This type of design is more efficient, but requires controls to assure that an arc is not established. It would be obvious to one skilled in the art that other reactor designs could be used.

FIG. 6, illustrates one embodiment of a reactor 60 that utilizes two electrodes, 62 and 64, made from either metal mesh, expanded metal or perforated metal. This design allows air to pass through the electrodes. In the space between the electrodes is a nonconductive porous substrate that contains the adsorbent 66. In normal operation, the air passes through the reactor and the contaminants are adsorbed. This design could be considered a dielectric barrier discharge or a corona discharge, depending on the design of the porous media between the electrodes, and whether the electrodes are coated with a dielectric material.

FIG. 7 illustrates an embodiment of a reactor 70 similar to the reactor shown in FIG. 6, except the nonconductive porous media 76 which contains an adsorbent material and has been placed in the air flow following the two electrodes 72 and 74. In this design the air flows past the electrodes 72 and 74 and the high energy electrons are created and the air molecules that are ionized pass through the porous media 76. The free radicals in the air desorb and oxidize the contaminants that are trapped on the adsorbent held within the porous media 76. This design can be a dielectric barrier discharge or a corona discharge, depending on the design of the electrodes. During the desorption/regeneration mode this design requires some air movement to move the free radicals into the porous media 76.

FIG. 8 illustrates another reactor embodiment 80 that utilizes the porous media 84 as one of the electrodes. The electrical discharge takes place between the conductive mesh electrode 82, and the closest surface of the conductive porous media 84. This reactor functions similar to the reactor illustrated in FIG. 7, in that the ions and free radicals are created and them pass through the porous media. This reactor can be designed as a dielectric barrier discharge or a corona discharge depending on the design of the conductive mesh electrode.

FIG. 9 illustrates a reactor design 90 that utilizes parallel plates 95 that have been coated with an adsorbent 96 and have alternate polarity. The composition of the adsorbent coating 96 can determine if this reactor design is a corona discharge or a dielectric barrier discharge.

FIG. 10 illustrates a reactor design 100 that is similar to the reactor shown in FIG. 9, except the plates 102 all have the same polarity. The electrode with the alternate polarity 104 is comprised of a wire or rod between the plates. The electrode could also be a plate or mesh, between the plates coated with the adsorbent 106. If the adsorbent coating 106 can act as a dielectric barrier, then the reactor will be of that design. The type of reactor could also be operated as a corona discharge, depending on the adsorbent coating.

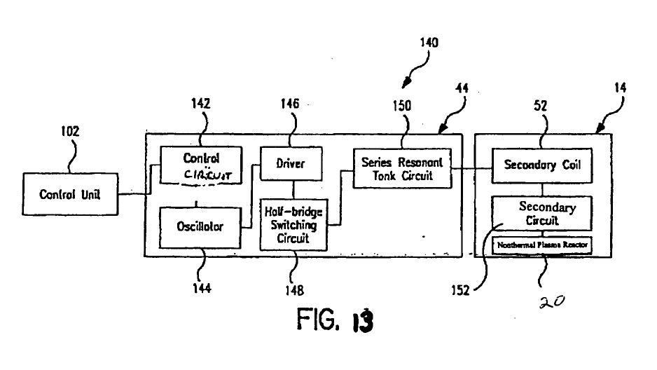

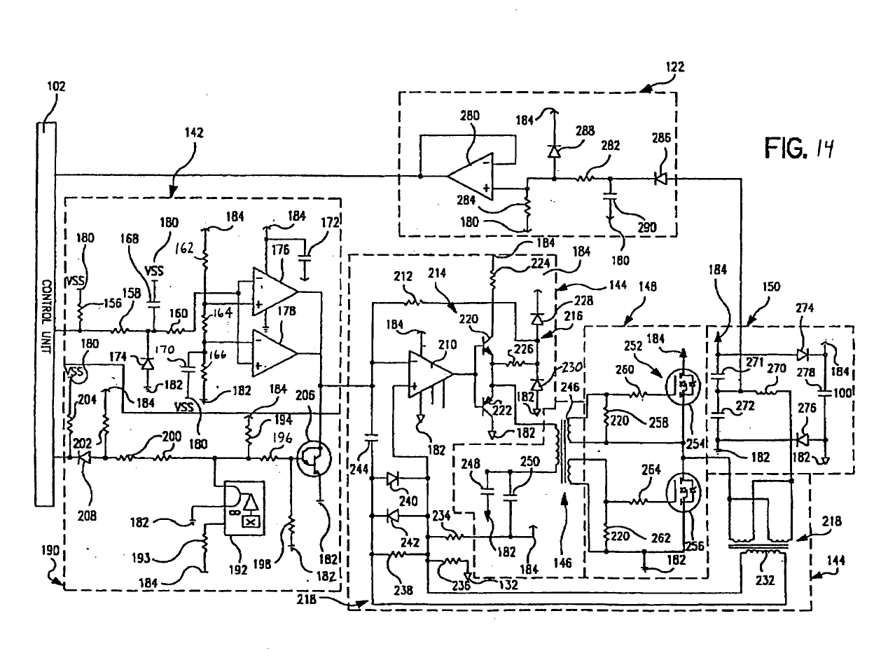

Further electrode designs are illustrated in FIG. 11. Sheet metal would be die cut on the solid lines as shown in the figures, or a similar pattern, forming numerous triangles cut through the metal. The sides of the triangles could be die cut with a sawtooth type edge, to increase the number of points. The triangle form would then be folded on the dashed line, 90 degrees, forming a porous electrode that could have a multitude of points that would aid in passing the high energy electrons into the air. These drawings are only intended to show a small section of an electrode, because the ideal electrode would have many of points on it.

As noted above, FIG. 19 depicts the reactor 20′ of air treatment system 10′. In the illustrated embodiment, the reactor 20′ generally includes a pair of mesh electrodes 24′ and 26′. The electrodes may be manufactured of stainless steel to resist corrosion and provide relatively long life. A dielectric material and/or decomposition catalyst may be added between the electrodes 24′ and 26′, but is not strictly necessary to operation of the reactor 20′.

Power Supply

To provide efficient and proper operation in the face of the changing characteristics of the bed, the present invention may, as in the described embodiment, include a dynamic power supply that adjusts to changes in the operating parameters of the nonthermal plasma reactor. The power supply preferably includes a primary circuit and a secondary circuit that are coupled to one another by an inductive coupling. In a first aspect, the power supply has the ability to adjust power output to match the load and maintain resonance, which is described in more detail below. This permits a smaller and more efficient power supply. With conventional power supplies, the power supply would be tuned to match the load at certain pre-selected characteristics. As a result, efficiency (and possibly proper operation) is compromised when the load does not match the pre-selected characteristics to which the power supply is tuned. Although a pre-tuned power supply can be used, a dynamic power supply, such as the power supply described below, provides marked benefits. This design can be used to span a pre-defined range of frequencies and automatically maintain the system at resonant frequency. As an additional benefit, the inductive coupling preferably includes an air gap that can be designed to limit current across the gap, thereby limiting the formation of thermal streamers within the nonthermal plasma reactor. If a thermal streamer forms the current starts to spike and is immediately limited. The transient discharges that are known as streamers can be arrested when the electric field is reduced to the point where electron attachment becomes dominant. This identifies the transformation of a streamer or transient discharge to a thermal streamer. The current used to maintain a thermal streamer is much larger and can have an adverse affect on the bed by causing carbonization. The limiting of thermal streamers through the reactor under various operating conditions while maintaining effective and efficient control of the streamer potential becomes very essential to a low cost system. Having a system that limits the voltage potential as the reactor changes and adjusts to resonance for variable operating conditions makes it easier to control the dynamics and contributes to a small low cost system. The power limiting capability is also affected by the efficiency of the resonant center and how far off center the supply is as compared to the load. The load can be pre-matched to the optimum frequency and operating point by designing for the proper impedance and selecting a matching capacitor on the load side either in series or parallel depending on the drive method. The power supply can be used to generate the AC that charges the high voltage capacitor. It can be used to charge an AC capacitor and control the AC signal imposed on the high voltage DC. This power supply can be used as an AC power source. The frequency of drive is dependent on the design of the bed and the ability to correct for resonance over the expected operation range.

In an embodiment, the power supply also includes a control system for adjusting the power supplied to the nonthermal plasma reactor based operational characteristics, such as the impedance of the adsorbent bed or the impedance of the reactor. For example, the reactor impedance can be determined by submitting the bed to a high voltage pulse while monitoring power consumption. A bed with higher humidity will consume more power and will run at different frequencies then a bed with lower humidity. The reactor impedance could be measured with a low voltage potential but the high voltage pulse allows a more complete analysis of the load. This added power translates to heat and is subsequently used to drive off moisture. The moisture and air together create a gas. The presence of O₂ and H₂O in the air makes the air or gas around the reactor bed electronegative. The heat driving off the moisture absorbed by the bed specifically enhances this effect. The control sequence of the present embodiment would be designed to test the bed and start at a power level that will drive off moisture in a safe range as to not damage the bed. The power can be easily monitored using the current feedback transformer on the power supply. It must also be mentioned that the span of the self seeking resonant supply discussed prior can be designed to cover the range of the reactor impedance. Power could also be chosen to limit the drying process of the bed. Voltage may easiest parameter to control in this embodiment. The voltage applied is varied along a curve that is inverse to the humidity within the reactor. That is to say that the lower the humidity needs a higher voltage to create a non thermal plasma and higher humidity situations may not establish a non-thermal plasma but creates enough heat to drive off moisture until the bed is regenerated. The design can allow for resonance while monitoring bed impedance and driving off moisture to reach optimum non-thermal plasma.

The power supply controls described above are applicable to several types of non-thermal plasmas and drive techniques. The following paragraphs address some of the drive and switch methods that can be used with these controls.

A. Pulsed AC

The AC power supply as described becomes quite effective in the pulse control. The frequency and pulse control or rise times can be controlled by bed impedance. To achieve a faster rise time the design of the bed will be adjusted to allow a higher resonant frequency. This is accomplished by changing the bed capacitance and resistance. The adjustments to resonance are performed using multiple beds, using series beds, parallel beds, or any combination to allow the frequency to be selected within the physics of the selected materials. The bed thickness may require a different number of beds, for example, two or twenty beds in series. Making a bed thinner or thicker can help control the capacitance and resistance. Controlling the square inches of electrode area also control the resistance and capacitance. The combination of these characteristics will in large part determine the resonant frequency of the bed at specific drive and bed conditions.

B. Pulsed DC

In this design, the AC self-resonant power supply is rectified and charges a high voltage capacitor. The same control methodology is used but the switching is also controlled to the resonance of the bed. This is not required for function, but may improve the efficiency of the system. The same type of self-resonant power supply is used to create the DC and then switch the DC at a resonant frequency.

C. DC with Pulsed AC

The DC with an AC ripple is very conducive to synergistic results. The DC is suspected to provide a DC corona while the AC also allows the AC corona discharge. With the DC voltage level at a point of creating a DC discharge and an AC discharge that creates the streamers added to this DC voltage both discharges are created. This means that the AC can have less rise time to get the same result because the potential is already at the DC level and only has to be increased to the point of creating the streamer.

An embodiment of the power supply will now be described in detail with reference to FIGS. 12 through 17. Referring to FIGS. 1 and 12, the inductively coupled ballast circuit 140 is a self-oscillating, half-bridge switching design that operates at high frequencies. The inductively coupled ballast circuit 140 self-oscillates once resonance is achieved, uses MOSFET transistors as switching elements, and is designed to accommodate an air-core transformer coupling arrangement, which simplifies the design of the nonthermal plasma reactor assembly 20. The nonthermal plasma reactor assembly 20 may be readily replaced because of the air-core transformer coupling arrangement created by the inductively coupled ballast circuit 140.

As illustrated in FIG. 13, the inductively coupled ballast circuit 140 of the described embodiment generally includes a control unit 102, a control circuit 142, an oscillator 144, a driver 146, a half-bridge switching circuit 148, a series resonant tank circuit 150. The nonthermal plasma reactor assembly 14 generally includes the secondary coil 52, the secondary circuit 152 and the nonthermal plasma reactor 20 (See FIG. 1). The oscillator 144 is electrically connected with the control circuit 142, which energizes the oscillator 144 by providing electric signals to the control circuit 142. During operation, the oscillator 144 provides electrical signals to direct the driver 146, which then causes the half-bridge switching circuit 148 to become energized. The half-bridge switching circuit 148 energizes the series resonant tank circuit 150 that, in turn, inductively energizes the nonthermal plasma reactor 20.

As noted above and as further illustrated in FIG. 13, the nonthermal plasma reactor assembly 14 includes the secondary coil 52, the resonant secondary circuit 152 and the nonthermal plasma reactor 20 while the electronic assembly 44 houses the control circuit 142, the oscillator 144, the driver 146, the half-bridge switching circuit 148 and the series resonant tank circuit 150. As previously set forth, once the series resonant tank circuit 150 is energized, the secondary coil 52 in the nonthermal plasma reactor assembly 14 becomes inductively energized, which is illustrated by the line between the resonant tank circuit 150 and the secondary coil 52 in FIG. 13. The range of frequencies over which the ballast circuit operates may be varied based on an anticipated range of characteristics of the bed. As known to those skilled in the art, the resonant frequency may be any desired frequency selected as a function of the component selection in the series resonant tank circuit 150 and the nonthermal plasma reactor assembly 14.

Referring to FIG. 14, the control circuit 142 is electrically connected with the control unit 102 and the oscillator 144. The control circuit 142 includes a plurality of resistors 156, 158, 160, 162, 164, 166, a plurality of capacitors 168, 170 172, a diode 174, a first operational amplifier 176 and a second operational amplifier 178. As illustrated, resistor 156 is connected with a first direct current (“DC”) power source 180, the output of the control unit 102 and resistor 158. Resistor 158 is further connected with diode 174, resistor 160 and capacitor 168. The first DC power source 180 is connected with capacitor 168, which is also connected with diode 174. Diode 174 is further connected with a ground connection 182, as those skilled in the art would recognize. Resistor 160 is connected with the negative input of operational amplifier 176 and the positive input of operational amplifier 178 to complete the current path from the control unit 102 to the operational amplifiers 176, 178.

Referring once again to the control circuit 142 depicted in FIG. 14, resistor 162 is connected with a second DC power source 184 and in series with resistors 164 and 166. Resistor 166 is connected with the ground connection 182 and capacitor 170, which is, in turn, connected with the first DC power source 180 and resistor 164. The positive input of operational amplifier 176 is electrically connected between resistors 162 and 164, which provides a DC reference voltage to operational amplifier 176 during operation. The negative input of operational amplifier 178 is electrically connected between resistors 164 and 166, which provides a DC reference voltage to operational amplifier 178 during operation. The output of operational amplifiers 176 and 178 is connected with the oscillator 144, as set forth in detail below.

During operation, the control circuit 142 receives electrical signals from the control unit 102 and, in turn, acts as a window comparator that only switches when the input voltage produced by the control unit 102 is within a certain voltage window. The preferred signal from the control unit 102 is an AC signal that, together with its duty cycle, allows the control unit 102 to turn the nonthermal plasma reactor 20 on and off through the remaining components of the inductively coupled ballast circuit 140, as will be set forth below. The control circuit 142 also prevents false triggering and allows positive control if the control unit 102 fails.

As illustrated in FIG. 14, the first DC power source 180 and the second DC power source 184 provide power to the circuits depicted in FIG. 14. Those skilled in the art of electronics would recognize that DC power supply circuits are well known in the art and beyond the scope of the present invention. For the purposes of the present invention, it is important to note that such circuits exist and are capable of being designed to produce various DC voltage values from a given AC or DC power source. Those skilled in the art would recognize that the circuits disclosed in FIG. 5 could be designed to operate on various DC voltage levels, as desired, and that the present invention should not be limited to any particular DC voltage level.

In the embodiment depicted in FIG. 14, the output of the control circuit 142 is connected with an interlock circuit 190 to prevent the nonthermal plasma reactor 60 from becoming energized if the air treatment system 10 is not properly assembled. The interlock circuit 190 includes a magnetic interlock sensor 192, a plurality of resistors 193, 194, 196, 198, 200, 202, 204, a transistor 206 and a diode 208. The magnetic interlock sensor 192 is positioned so that if a shroud or covering for air treatment system 10 is not securely positioned, the air treatment system 10 will not energize the nonthermal plasma reactor 20. Those skilled in the art would recognize that the magnetic interlock sensor 192 might be placed in any convenient place of the air treatment system 10.

Referring to FIG. 14, the magnetic interlock circuit 190 operates by directing the output of the control circuit 142 to the ground connection 182, through transistor 206, if the magnetic interlock sensor 192 detects that the air treatment system 10 is not assembled properly, as set forth above. As those skilled in the art would recognize, if the air treatment system 10 is not assembled properly, the output of the magnetic interlock sensor 192 causes the current flowing through resistors 194, 196 and 198 to energize the gate of transistor 206, which thereby shorts the output signal of the control circuit 142 to the ground connection 182. The magnetic interlock sensor 192 is powered by the second DC power source 184 through resistor 193 and is also connected with the ground connection 182. In addition, the magnetic interlock sensor 192 sends a signal to the control unit 102, through the combination of resistors 200, 202 and 204, diode 208, first DC power source 180 and second DC power source 184. This signal also allows the control unit 102 to determine when the air treatment assembly 10 is not assembled properly. To that end, the interlock circuit 190 provides two methods of ensuring that the nonthermal plasma reactor 20 is not energized if the air treatment system 10 is not assembled properly. The magnetic interlock is not necessary for the operation of the present invention.

Referring once again to FIG. 14, the oscillator 144 provides electrical signals that energize the driver 146 while the air treatment system 10 operating. The oscillator 144 begins operating immediately once an electrical signal is sent from the control unit 102, through control circuit 142, as set forth above. As readily apparent, the oscillator 144 may also be controlled by any other mechanism capable of activating and deactivating the oscillator 144. The illustrated oscillator 144 comprises an operational amplifier 210, a linear bias resistor 212, a buffer circuit 214, a buffer feedback protect circuit 216 and a positive feedback circuit 218. During operation, the operational amplifier 210 receives input signals from the control circuit 142, the linear bias resistor 212 and the positive feedback circuit 218. The operational amplifier 210 is also connected with the second DC power source 184 and the ground connection 182, which energizes the operational amplifier 210.

As illustrated in FIG. 14, the illustrated buffer circuit 214 comprises a first transistor 220, a second transistor 222 and a pair of resistors 224, 226. The output of operational amplifier 210 is connected with the gates of transistors 220, 222, thereby controlling operation of transistors 220, 222. The second DC power source 184 is connected with resistor 224, which is also connected with collector of transistor 220. The emitter of transistor 220 is connected with resistor 226, the emitter of transistor 222 and the input of the driver 146. The collector of transistor 222 is connected with ground connection 182. During operation, the buffer circuit 214 buffers the output signal from the operational amplifier 210 and prevents load changes from pulling the frequency of oscillation. In addition, the buffer circuit 214 increases the effective gain of the inductively coupled ballast circuit 140, which helps ensure a quick start of the oscillator 144.

The buffer feedback protect circuit 216 comprises a pair of diodes 228, 230 that are electrically connected with the output of the buffer circuit 214 by resistor 226. As illustrated in FIG. 5, the second DC power source 184 is connected with the cathode of diode 228. The anode of diode 228 and the cathode of diode 220 are connected with resistor 226 and the linear bias resistor 212. The linear bias resistor 212 provides bias feedback signals to the negative input of operational amplifier 210. In addition, the anode of diode 230 is connected with ground connection 182, which completes the buffer feedback protect circuit 216. The buffer feedback circuit 216 protects the buffer circuit 214 from drain to gate Miller-effect feedback during operation of the reactor 20.

As illustrated in FIG. 14, the current sensing circuit or positive feedback circuit 218 includes a first multi-winding transformer 232, a plurality of resistors 234, 236, 238, a pair of diodes 240, 242, and a capacitor 244. The transformer 232 preferably includes two primary coils that are connected in parallel between the output of the half-bridge switching circuit 148 and the input of the series resonant tank circuit 150 as illustrated in FIG. 5. The transformer 232 preferably includes two primary coils connected in series rather than a single primary coil to reduce the total reactance on the primary side of the transformer, thereby reducing the reactive impact of the transformer 232 on the tank circuit 150. In other applications, the primary side of the transformer may be divided into a different number of primary coils. For example, the transformer 232 may include only a single primary coil where reduction of the reactive impact of the transformer is not important or may include three or more primary coils where even further reduction of the reactive impact of the transformer 232 is desired.

The first lead of the secondary coil of transformer 232 is electrically connected with resistors 234, 236, 238, the diodes 240, 242 and the positive input of the operational amplifier 210. The second lead of the secondary coil of the transformer 232 is connected with resistor 238, the cathode of diode 242, the anode of diode 240 and capacitor 244. As such, resistor 238 and diodes 242, 244 are connected in parallel with the secondary winding of transformer 232, as illustrated in FIG. 5. Capacitor 244 is also electrically connected with the negative input of operational amplifier 210. In addition, resistor 234 is connected with the second DC power source 184 and resistor 236 is connected with the ground connection 182. Resistors 234, 236 and 238 protect the operational amplifier 210 from current overload and diodes 240, 242 clip the feedback signal that is sent to the input of the operational amplifier 210.

During operation, the oscillator 144 receives signals from the control circuit 142 that charges capacitor 244, which, in turn, sends an electrical signal to the negative input of the operational amplifier 210. The output of the operational amplifier 210 is electrically directed to the driver 146, which energizes the half-bridge switching circuit 148. As illustrated in FIG. 14, the transformer 232 is connected in this current path and sends electrical signals back through resistors 234, 236 and 238, which limits the current, and eventually directs the electrical signal back to the inputs of the operational amplifier 210 to provide a current sensing feedback. The current sensing feedback provided by transformer 232 allows the oscillator 144 to self-resonate and the inductively coupled ballast circuit 103 remains oscillating until the control unit 102 shuts the air treatment system 10 down or transistor 206 of the interlock circuit 190 pulls the input to the oscillator 144 low.

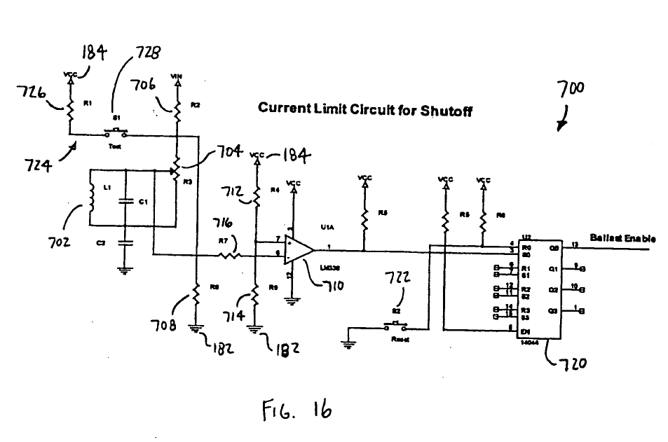

More specifically, the positive feedback circuit 218 (or current sensing circuit) provides feedback to the operational amplifier 210 that controls the timing of the oscillator 144 so that the oscillator 144 does not impair the tank circuit's 150 inherent tendency to oscillate at resonant frequency. In general, the current in the series resonant tank circuit 150 flows through the primary coils of transformer 232, thereby inducing a voltage in the secondary coil of transformer 232. The AC signal generated by the transformer 232 is superimposed upon a DC reference signal set by resistors 234 and 236. The operational amplifier 210 is preferably a conventional difference operational amplifier providing an output based, in part, on the difference between the amplitude of the signal on the positive lead and the amplitude of the signal of the negative. Given that opposite leads of the operational amplifier 210 are connected to opposite sides of the secondary coil of the transformer 232, the signal applied to the positive lead of the operational amplifier 210 is essentially equal in magnitude, but opposite in polarity from the signal applied to the negative lead of the operational amplifier 210. Accordingly, the output of the operational amplifier 210 oscillates above and below the reference signal in accordance with the oscillating signal of the current feedback circuit. The operational amplifier 210 is preferably alternately driven between saturation and cutoff, thereby providing a quasi-square wave output. When the output of the operational amplifier 210 exceeds the reference signal, transistor 220 is driven to “on,” while transistor 222 is driven to “off,” thereby charging capacitor 248 and discharging capacitor 250. When the output of the operational amplifier 210 falls below the reference signal, transistor 222 is driven to “on” while transistor 220 is driven to “off,” thereby discharging capacitor 248 and charging capacitor 250. This alternating charging/discharging of capacitors 248 and 250 results in an alternating signal being applied to the primary coil of the driver 146, as described in more detail below. The frequency shifting (or resonance seeking) operation of the circuit is described in more detail with reference to FIG. 15. In this illustration, the current in the primary coil is represented by waveform 600, the voltage in the current transformer 232 is represented by waveform 602 and the current feedback signal is represented by waveform 604 (shown without clipping of diodes 240 and 242). As noted above, the operational amplifier 210 is alternately driven between saturation and cutoff with a transition period interposed between the saturation and cutoff portions of the waveform. The length of the transition period is dictated by the slope of the current feedback signal. The timing of the operational amplifier 210 is dependent on the length of the transition period. By varying the length of the transition period, the timing of the transitions in the operational amplifier 210 output signal is controlled. This shift in timing is perpetuated through the driver 146, which truncates the signal in the tank circuit 150. The truncated signal in the tank circuit 150 is reflected into the current feedback signal by the current transformer 232 to perpetuate the frequency shift. When an increased load is applied to the secondary circuit, a corresponding increase occurs in the amplitude of the current in the tank circuit 150. This increased signal is represented by waveform 606 in FIG. 15. The increased signal in the tank circuit 150 results in a corresponding increase in the voltage in the current transformer 232. The increased voltage in the current transformer 232 is represented by waveform 608. The increased voltage in the current transformer 232 finally results in an increase in the amplitude of the current feedback signal, represented by waveform 610 (shown without clipping of diodes 240 and 242). The increased current feedback signal has a greater slope at the zero crossings and therefore causes the operational amplifier 210 to transition from one state to the other sooner in time. This in turn causes the transistors 220 and 222 to switch sooner in time and the AC signal applied to the driver 146 to alternate sooner in time. Ultimately, there is a corresponding shift in the timing of the signals applied to the tank circuit 150 by the half-bridge switching circuit 148. The shift in timing of the signals applied by the switching circuit 148 has the effect of truncating the inherent oscillating signal in the tank circuit 150, thereby shifting the timing of the signal in the tank circuit 150. The truncated signal in the tank circuit 150 is reflected into the current sensing circuit 218. This varies the current feedback signal applied to the operational amplifier 210, thereby perpetuating the time shift and effecting an upward increase in the frequency of the oscillator. In this way the oscillator 144 and driver 146 permit the tank circuit 150 to shift its frequency to remain at resonance despite a change in load. When a decrease in the load applied to the secondary circuit occurs, the frequency of the oscillator 144 decreases in a manner essentially opposite that described above in connection with an increase in frequency. In summary, the decreased load results in decreased current in the tank circuit 150. This results, in turn, in a decrease in the voltage induced in the current transformer 232 and a decrease in the amplitude of the current feedback signal. The decreased current feedback signal has a decreased slope, and accordingly causes the operational amplifier 210 to complete the transition between saturation and cutoff later in time. The transistors 220 and 222 also transition later in time, thereby shifting the timing of the driver 146 and the timing of the switching circuit 148. The net effect of the shift in the timing of the switching circuit 148 is to extend the signal in the tank circuit 150. The extended signal is reflected into the current sensing circuit 218 where it is returned to the operational amplifier 210 to perpetuate the decrease in frequency of the oscillator 144. Optimal performance is achieved when the half-bridge switching circuit 148 alternates at the zero crossings of the current signal in the tank circuit 150. This provides optimal timing of the energy supplied by the switching circuit 148 to the tank circuit 150. In some applications, it may be necessary or desirable to shift the phase of the current feedback signal to provide the desired timing. For example, in some applications, the parasitic effect of the various circuit components may result in a shift in the phase of the current feedback signal. In such applications, the current sensing circuit can be provided with components, such as an RC circuit, to shift the signal back into alignment so that the switching circuit 148 alternates at the zero crossings. FIG. 17 illustrates a portion of an alternative current sensing circuit 218′, which includes an RC circuit configured to shift the phase of the current feedback signal 120 degrees. In this embodiment, the current sensing circuit 218′ is essentially identical to the current sensing circuit 218 of the above described embodiment, except that it includes two capacitors 800, 802 and two resistors 804, 806 that are connected along the leads extending back to the operation amplifier 210. FIG. 17 further illustrates that the secondary of the current transformer 232 can be connected to ground 182 to provide a zero reference, if desired.

Referring once again to FIG. 14, the output of the oscillator 144 is electrically connected with the driver 146, which comprises the first primary winding of a second multi-winding transformer 246 in the illustrated embodiment. In this embodiment, the second transformer 246 is the preferred driver 146 because the phasing arrangement of the transformer 246 insures that the half-bridge switching circuit 148 will be alternately driven, which avoids shoot-through conduction. A double arrangement of capacitors 248, 250 is electrically connected with the second primary winding of transformer 246, thereby preventing DC current overflow in the transformer 246. Capacitor 246 is also connected with the ground connection 182 and capacitor 250 is also connected with the second DC power source 184.

Both secondary coils of transformer 246 are electrically connected with the half-bridge switching circuit 148, which receives energy from transformer 246 during operation. The half-bridge switching circuit 148, which is also illustrated in FIG. 5, is electrically arranged as a MOSFET totem pole half-bridge switching circuit 252 that is driven by both secondary coils of transformer 246. The MOSFET totem pole half-bridge switching circuit 252 includes a first MOSFET transistor 254 and a second MOSFET transistor 256 that provide advantages over conventional bipolar transistor switching circuits. Energy is transferred from the driver 146 to the MOSFET transistors 254, 256 through a plurality of resistors 258, 260, 262, 264. The MOSFET transistors 254, 256 are designed to soft-switch at zero current and exhibit only conduction losses during operation. The output generated by MOSFET transistors 254, 256 is more in the form of a sine wave that has fewer harmonics than that generated by traditional bipolar transistors. Using MOSFET transistors 254, 256 also provides advantages by reducing radio frequency interference that is generated by the MOSFET transistors 254, 256 while switching during operation.

In the half-bridge switching circuit 148 depicted in FIG. 14, the first secondary coil of transformer 246 is connected with resistor 258 and resistor 260. The second secondary coil of transformer 246 is connected with resistor 262 and resistor 264. Resistor 260 is connected with the gate of MOSFET transistor 254 and resistor 264 is connected with the gate of MOSFET transistor 256. As illustrated, the first secondary coil of transformer 246 and resistor 258 are connected with the emitter of MOSFET transistor 254. The second secondary coil of transformer 246 and resistor 264 are connected with the gate of MOSFET transistor 256. The collector of MOSFET transistor 254 is connected with the second DC power source 184 and the emitter of MOSFET transistor 254 is connected with the collector of MOSFET transistor 256. The emitter of MOSFET transistor 256 and resistor 262 are connected with the ground connection 182.

A further benefit of the driver 146 is that multi-winding transformer 246 is a very convenient way to apply gate drive voltage to the MOSFET transistors 254, 256 that exceeds the second DC power source 184. The MOSFET transistors 254, 256 provide further advantages because they have diodes inherent in their design that protect the MOSFET totem pole half-bridge switching circuit 252 from load transients. In addition, over-voltages reflected from the series resonant tank circuit 150, by changes in load, are returned to supply rails by the inherent diodes within MOSFET transistors 254, 256.

Referring to FIG. 14, the output of the half-bridge switching circuit 148 is connected with the input of the series resonant tank circuit 150, which, in turn, inductively energizes the secondary coil 52 of the nonthermal plasma reactor assembly 20 (FIG. 1). As set forth above, in the illustrated embodiment of the invention, the positive feedback circuit 218 of the oscillator 144 is connected with the output of the half-bridge switching circuit 148 and the input of the series resonant tank circuit 150 to provide current sense feedback to operational amplifier 210 of the oscillator 144 during operation. The output of the half-bridge switching circuit 148 is connected with the input of the series resonant tank circuit 150 by the secondary coil of transformer 232 as illustrated in FIG. 14.

Referring to FIG. 14, the series resonant tank circuit 150 comprises an inductive coupler 270, the parallel combination of a pair of tank capacitors 271, 272, a pair of diodes 274, 276 and a capacitor 278. The inductive coupler 270 is connected with the secondary coil of transformer 232 and between tank capacitors 271, 272. Tank capacitor 271 is also connected with the second DC power source 184 and tank capacitor 272 is also connected with the ground connection 182. In addition, tank capacitor 271 and the second DC power source 184 are connected with the anode of diode 274. The cathode of diode 274 and capacitor 278 are both connected with the second DC power source 184. Capacitor 278 is connected with the anode of diode 276 and the ground connection 182. Tank capacitor 272 is also connected the cathode of diode 276.

It is important to note that the series resonant tank circuit 150 sees all of the stray inductances of the component combination of the inductively coupled ballast circuit 140. This is important because the stray inductance, which is the combined inductance seen by the series resonant tank circuit 150, will limit the power transfer dramatically to the load (the nonthermal plasma reactor assembly 20) under any condition outside resonance. The inductance of the secondary coil 52 and the secondary circuit 152 are also reflected impedance values that help determine and limit the power that is delivered to the secondary coil 52 of the nonthermal plasma reactor assembly 20. In general, brute force oscillator/transformer combinations have power transfer limits because of stray and reflected inductance. In other words, the inductance of transformers and capacitors appears in series with the load thereby limiting power transfer capability.

In the illustrated embodiment, the frequency of operation for the series resonant tank circuit 150 is determined by the inductance of the inductive coupler 270 and the parallel capacitance value of tank capacitors 271, 272, which will vary from application to application depending, in large part, on the characteristics of reactor bed. Tank capacitors 271, 272 must have low dissipation factors and be able to handle high levels of current. As noted above, the ballast circuit 140 seeks resonance through a feedback signal from the current sensing circuit 218. The current feedback signal is proportional to the current in the resonant tank circuit 150. The range of frequencies through which the ballast circuit 103 can search for resonance are readily varied by adjusting the values of the tank capacitors 271, 272. For example, by increasing the value of the tank capacitors 271, 272, the range can generally be decreased.

The number of turns of wire in the primary and secondary coils of the inductive coupler 270 will vary from application to application depending on the power requirements of the particular nonthermal plasma reactor assembly 20. In the illustrated embodiment, litz wire is used for the inductive coupler 270 because litz wire is especially efficient in both performance and operating temperature, due to a fringing effect caused by the high currents that are created while operating at high frequencies. As set forth above, the inductive coupler 270 inductively energizes the secondary coil 52 of the nonthermal plasma reactor assembly 20 during operation.

In the described embodiment, the primary and secondary coils of the inductive coupler 270 are separated by an air gap. The gap between the primary and secondary coils of the inductive coupler 270 may be used to adjust the coupling coefficient, thereby adjusting the operating point of the nonthermal plasma reactor 20. The permeance of the air gap between the inductive coupler 270 and the secondary coil 52 may be adjusted by changing the distance between the inductive coupler 270 and the secondary coil 52, as known in the art. As is apparent, the air gap within the air core transformer formed with the inductive coupler 270 and the secondary coil 52 may be selectively adjusted to limit power transfer from the inductive coupler 270 to the secondary coil 52. In addition, selective adjustment of the air gap may adjust the control response of the oscillator 144. Accordingly, selection of the permeance of the air gap balances overcurrent protection of the inductively coupled ballast circuit 140 with the bandwidth and responsiveness of the oscillator 144 when the secondary coil 52 is inductively energized.

As known in the art, inductive energization of the secondary coil 52 occurs when the inductive coupler 270 induces a magnetic flux in the air gap between the secondary coil 52 and the inductive coupler 270. In the illustrated embodiments, the magnetic flux is an alternating flux with a frequency that is preferably controlled by the oscillator 144 in an effort to maintain resonance.

During operation, the oscillator 144 may control the frequency at close to the resonant frequency of the series resonant tank circuit 150 and the nonthermal plasma reactor assembly 20. As previously discussed, the positive feedback circuit 218 monitors the reflected impedance in the series resonance tank circuit 150 to allow the inductively coupled ballast circuit 140 to self-oscillate to a frequency which optimizes power transfer efficiency. If, for example, the impedance reflected by the nonthermal plasma reactor assembly 14 to the series resonant tank circuit 150 shifts slightly, the positive feedback circuit 218 may adjust the frequency to correct for the shift in power transfer efficiency.

In the case where the impedance shifts significantly lower, such as, for example, when the nonthermal plasma reactor 60 fails in a shorted condition, the increase in current is limited by the air gap. As known in the art, the air gap functions to limit the amount of impedance that may be reflected. In addition, the impedance that is reflected may result in an impedance mismatch causing the reflection of power back to the series resonant tank circuit 150. As is readily apparent, the reflection of power to the series resonance tank circuit 150 may further limit power transfer to the secondary coil 52. Based on the combination of the air gap and the resonant frequency control, the inductively coupled ballast circuit 140 may be optimized for efficient operation while maintaining desirable levels of overcurrent protection.

The configuration of the air core transformer provides for simple and efficient replacement of the nonthermal plasma reactor assembly 20. In addition, the present invention provides further advantages by providing a coupling that does not require special contacts for the nonthermal plasma reactor assembly 20 because of the inductively coupled ballast circuit 103. Further, the configuration eliminates the need for conductors or other similar power transfer mechanisms that may compromise waterproofing, corrode and/or otherwise malfunction.

Referring once again to FIG. 14, the ballast feedback circuit 122 is electrically connected with the inductive coupler 270 of the series resonant tank circuit 150 and the control unit 102. The ballast feedback circuit 122 provides feedback to the control unit 102 while the inductively coupled ballast circuit 103 is providing power to the nonthermal plasma reactor 60. This allows the control unit 102 to monitor the energy being provided by the inductive coupler 270 to the secondary coil 52 of the nonthermal plasma reactor assembly 20. This provides the control unit 102 with the ability to determine if the nonthermal plasma reactor 20 is on or off and also, in other embodiments, the amount of current and voltage being applied to the nonthermal plasma reactor 20.

As depicted in FIG. 14, the ballast feedback circuit 122 includes an operational amplifier 280, a pair of resistors 282, 284, a pair of diodes 286, 288 and a capacitor 290. The signal from the series resonant tank circuit 150 is directed to the anode of diode 286. The cathode of diode 286 is connected with capacitor 290 and resistor 282. In addition, resistor 282 is connected with the anode of diode 288, resistor 284 and the positive input of operational amplifier 280. Resistor 284 is also connected with the positive input of operational amplifier 280 and the first DC power source 180. Capacitor 290 is also connected with the first DC power source 180, while the cathode of diode 288 is connected with the second DC power source 184. The negative input of operational amplifier 280 is connected directly with the output of operational amplifier 280. The output of operational amplifier 280 is connected with the control unit 102, thereby providing the feedback signal from operational amplifier 280 to the control unit 102.

As noted above, the secondary circuit 152 may include a capacitor 312 that changes and limits the current supplied to the nonthermal plasma reactor 20 from the secondary coil 52 by changing the reflected impedance of the nonthermal plasma reactor 60 through the inductive coupler 270 (see FIG. 14) of the series resonant tank circuit 150. As is apparent, by selecting the value of capacitor 312 in view of the impedance of the nonthermal plasma reactor 60 and the secondary coil 52, the nonthermal plasma reactor assembly 20 may be impedance matched with the power source (the series tank circuit 150). In addition, the nonthermal plasma reactor assembly 20 may be tuned to resonate at a frequency similar to the resonant frequency of the series resonant tank circuit 150, thereby optimizing coupling and minimizing reflected power.

In one embodiment, the ballast circuit 140 also includes a current limit circuit 700 designed to monitor the current produce by the circuit, and shut the circuit down when it falls outside of desired parameters. The current limit circuit 700 can be configured to disable the ballast circuit 103 when a current threshold is exceeded (i.e. an upper limit) or when the current falls outside of a range (i.e. both upper and lower limits). Upper and lower limits are particularly useful in applications where low current and unstable operation can damage the load.

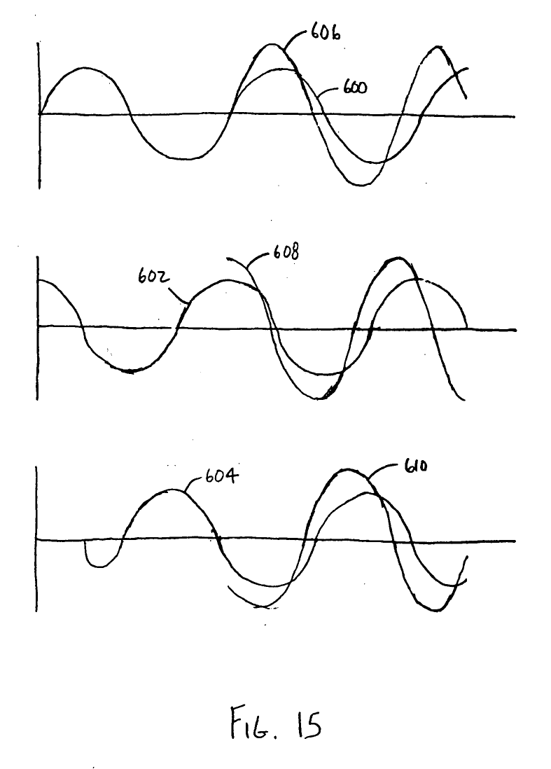

One embodiment of the current limit circuit 700 is shown in FIG. 16. The current limit circuit 700 includes a current sensing transformer 702 that produces current proportional to the flow of current to the primary coil 270. The current transformer 702 is preferably created by forming a coil of wire around the core of the current sensing transformer 232 of the current sensing circuit 218. The current from the current transformer 702 is dropped across resistor 704. Another resistor 706 is tied to the input voltage of ballast circuit. The relationship to the input voltage causes the level to shift as the input voltage shifts. This permits the current transformer 702 to track the real performance even as input voltage shifts. Resistor 708 allows a voltage bias from ground that helps to raise the variable current transformer voltage to a level detectable by the operational amplifier 710. Resistor 712 is connected between voltage source 184 and the positive input of operational amplifier 710. Resistor 714 is connected between ground connection 182 and the positive input of operational amplifier 710. Resistors 712 and 714 establish a limit or threshold to set the operating and non-operating modes. Resistor 716 is connected between the current transformer 70 and the negative input lead of operational amplifier 710 to prevent the operational amplifier 710 from drawing too much current from the current transformer 102. The output of the operational amplifier 702 is connected to integrated circuit 720, which is preferably a conventional latch or flip-flop, such as IC 14044. When the output from the operational amplifier 702 is driven high, the latch is triggered, thereby latching the disable signal. The integrated circuit 720 preferably maintains the ballast circuit 103 in the disabled condition until the manual reset switch 722 is pressed or otherwise actuated. Alternatively, the reset switch 722 can be replaced by a timer circuit (not shown) that resets the current limit circuit 700 after a defined period of time. The current limit circuit 700 may also include a test circuit 724 that permits testing of the operation of the current limit circuit 700. The test circuit 724 is connected to power source 184 and includes resistor 726 and switch 728. When switch 728 is depressed or otherwise actuated, current in excess of the threshold is applied to the operational amplifier 710. If operating properly, this current will cause the current limit circuit 700 to disable the ballast circuit 103.

As an alternative, the current from the current transformer 702 can be monitored by a microprocessor that is programmed to disable the ballast circuit when the current exceeds the desired threshold or falls outside of the desired range. In some applications, however, the microprocessor may not provide sufficient speed to provide acceptable response times.

The above description is that of various embodiments of the invention, including the preferred embodiment. Various alterations and changes can be made without departing from the spirit and broader aspects of the invention as defined in the appended claims, which are to be interpreted in accordance with the principles of patent law, including the doctrine of equivalents. Any reference to claim elements in the singular, for example, using the articles “a,” “an,” “the,” or “said” is not to be construed as limiting the element to the singular.

The embodiments of the invention in which an exclusive property or privilege is claimed are defined as follows:

1. An air treatment system for treating air within an environment comprising:
a housing having an inlet, an outlet and an air flow path connecting said inlet and said outlet;
an adsorbent material disposed along said flow path;
a nonthermal plasma reactor disposed along said flow path;
means for moving air from the environment through said inlet along said flow path and through said outlet back to the environment;
means for closing at least a portion of said flow path off from the environment, whereby said adsorbent material and said reactor are segregated from the environment; and
control means for operating the system in an adsorption phase during which air from the environment is moved through the system for treatment and a desorption/regeneration phase during which said closing means is actuated to segregate said adsorbent material and said reactor from the environment and said reactor means is actuated to treat contaminants within said housing.

2. The system of claim 1 further comprising recirculating means for recirculating air through said adsorbent material and said reactor during said desorption/regeneration phase.

3. The system of claim 2 wherein said adsorbent material is separated from said reactor and wherein air circulating through said adsorbent material and said reactor carries contaminants from said adsorbent material to said reactor for treatment.

4. The system of claim 3 wherein said recirculating means includes an air return defining an air flow path for recirculating air through the system.

5. The system of claim 4 wherein said recirculating means includes a means for closing said air return during said adsorption phase and for opening said air return during said desorption/regeneration phase.

6. The system of claim 5 wherein said adsorbent material includes an activated carbon fabric.

7. The system of claim 5 wherein said reactor includes a pair of spaced apart mesh electrodes.

8. The system of claim 7 wherein said reactor includes a dielectric material disposed between said electrodes.

9. The system of claim 8 wherein said reactor includes a catalyst disposed between said electrodes.

10. The system of claim 5 wherein said means for moving air includes a first fan, said first fan being powered off during said desorption/regeneration phase; and
wherein said recirculating means includes a second fan for recirculating air through the system during said desorption/regeneration phase.

11. The system of claim 10 further comprising a HEPA filter disposes along said flow path.

12. The system of claim 5 further comprising a heat source for causing thermal desorption of said adsorbent material during said desorption/regeneration phase.

13. The system of claim 11 wherein said dielectric material include alumina beads.

14. The system of claim 13 wherein said catalyst is manganese dioxide.

15. The system of claim 12 wherein said heat source includes a heat lamp.

16. The system of claim 15 wherein said control means includes means for engaging said heat lamp during said desorption/regeneration phase.

17. The system of claim 1 wherein said adsorbent material is disposed within said reactor.

18. The system of claim 17 wherein said means for moving air is deactivated during said desorption/regeneration phase.

19. The system of claim 18 wherein said adsorbent material includes a plurality of zeolites.

20. The system of claim 19 further comprising a dielectric material coated on said zeolites.

21. An air treatment system comprising:
a housing;
an adsorbent material disposed within said housing;
a nonthermal plasma reactor disposed within said housing;
an adsorption flow path passing through at least said adsorbent material;
a desorption/regeneration flow path passing through at least said adsorbent material and said reactor;
controls means for operating the system in an adsorption phase and a desorption/regeneration phase, during said adsorption phase said control means causing air to be moved from an environment through said adsorption flow path where said adsorbent material adsorbs contaminants carried in said air, during said desorption/regeneration phase said control means causing air to be moved through said desorption/regeneration flow path where said reactor destroys contaminants released by said adsorbent material.

22. The system of claim 21 wherein said adsorption flow path is at least partially coextensive with said desorption/regeneration flow path.

23. The system of claim 22 wherein said adsorption flow path includes an inlet and an outlet; and
control means includes a means for closing said inlet and said outlet during said desorption/regeneration phase and opening said inlet and said outlet during said adsorption phase.

24. The system of claim 23 wherein said control means includes a means for recirculating air through said desorption/regeneration flow path during said desorption/regeneration phase.

25. The system of claim 24 wherein said desorption/regeneration flow path includes an air return connecting a point downstream of said adsorbent material and said reactor to a point upstream of said adsorbent material and said reactor.

26. The system of claim 25 wherein said control means includes a means for closing air return during said adsorption phase and opening said air return during said adsorption phase.

27. The system of claim 26 wherein said reactor includes a pair of spaced apart electrodes.

28. The system of claim 27 wherein a dielectric material is disposed between said electrodes.

29. The system of claim 28 wherein said dielectric material includes a plurality of alumina beads.

30. The system of claim 28 further comprising a catalyst disposed in said desorption/regeneration flow path.

31. The system of claim 30 wherein said catalyst is disposed within said reactor.

32. The system of claim 29 further comprising a catalyst coated on said alumina beads.

33. The system of claim 21 further comprising a heat source disposed adjacent to said adsorbent material; and
wherein said control means includes means for activating said heat source during said desorption/regeneration phase.

34. The system of claim 33 wherein said heat source includes a heat lamp.

35. The system of claim 34 wherein said adsorbent material includes an adsorbent fabric.

36. The system of claim 35 wherein said adsorbent material is an activated carbon fabric.

37. A method for treating air in an environment comprising the steps of:
providing an air treatment system having an adsorbent material and a nonthermal plasma reactor in a housing;
moving air from the environment through at least the adsorbent material and returning it to the environment for a period of time during an adsorption phase;
segregating the adsorbent material and the reactor from the environment and activating the reactor for a period of time during a desorption/regeneration phase;
alternating operation of the system between the adsorption phase and the desorption/regeneration phase.

38. The method of claim 37 further comprising the step of recirculating air through the adsorbent material and the reactor during the desorption/regeneration phase.

39. The method of claim 38 wherein said recirculating step includes the step of moving air from a point downstream of the adsorbent material and the reactor to a point upstream of the adsorbent material and the reactor through an air return.

40. The method of claim 39 further comprising the steps of opening the air return during the desorption/regeneration phase and closing the air return during the adsorption phase.

41. The method of claim 40 further comprising the step of applying heat to the adsorbent material during the desorption/regeneration phase.

42. The method of claim 41 wherein said step of applying heat includes the step of activating a heat lamp located adjacent to the adsorbent material.

43. The method of claim 42 further comprising the step of providing the reactor with a pair of spaced apart electrodes and a dielectric material disposed between the electrodes.

44. The method of claim 43 further comprising the step of moving the air over a catalyst during the desorption/regeneration phase.

45. The method of claim 44 wherein the catalyst is coated on the dielectric material.
